(19) United States
(12) Patent Application Publication
(10) Pub. No.: US 2021/0109523 A1
(43) Pub. Date: Apr. 15, 2021

(54) SENSOR FIELD OF VIEW IN A SELF-DRIVING VEHICLE

(71) Applicant: Waymo LLC, Mountain View, CA (US)

(72) Inventors: Ming Zou, Mountain View, CA (US); Christian Lauterbach, Campbell, CA (US); Peter Morton, Mountain View, CA (US)

(21) Appl. No.: 16/598,060

(22) Filed: Oct. 10, 2019

(51) Int. Cl. G05D 1/00; G05D 1/02

(52) U.S. Cl. CPC G05D 1/0088; G05D 1/0257; G01S 2013/9364; G05D 1/0246; G05D 2201/0213; G05D 1/0231

(57) ABSTRACT

The technology relates to operation of a vehicle in a self-driving mode by determining the presence of occlusions in the environment around the vehicle. Raw sensor data for one or more sensors is received and a range image for each sensor based is computed based on the received data. The range image data may be corrected in view of obtained perception information from other sensors, heuristic analysis and/or a learning-based approach to fill gaps in the data or to filter out noise. The corrected data may be compressed prior to packaging into a format for consumption by onboard and offboard systems. These systems can obtain and evaluate the corrected data for use in real time and non-real time situations, such as performing driving operations, planning an upcoming route, testing driving scenarios, etc.

### BACKGROUND

Autonomous vehicles, such as vehicles that do not require a human driver, can be used to aid in the transport of passengers or cargo from one location to another. Such vehicles may operate in a fully autonomous mode or a partially autonomous mode where a person may provide some driving input. In order to operate in an autonomous mode, the vehicle may employ various on-board sensors to detect features of the external environment, and use received sensor information to perform various driving operations. However, a sensor's ability to detect an object in the vehicle's environment can be limited by occlusions. Such occlusions may obscure the presence of objects that are farther away and may also impact the ability of the vehicle's computer system from determining types of detected objects. These issues can adversely impact driving operations, route planning and other autonomous actions.

### BRIEF SUMMARY

The technology relates to determining the presence of occlusions in the environment around a vehicle, correcting information regarding such occlusions, and employing the corrected information in onboard and offboard systems to enhance vehicle operation in an autonomous driving mode.

According to one aspect of the technology, a method of operating a vehicle in an autonomous driving mode is provided. The method comprises receiving, by one or more processors, raw sensor data from one or more sensors of a perception system of the vehicle, the one or more sensors being configured to detect objects in an environment surrounding the vehicle; generating, by the one or more processors, a range image for a set of the raw sensor data received from a given one of the one or more sensors of the perception system; modifying, by the one or more processors, the range image by performing at least one of removing noise or filling in missing data points for the set of raw sensor data; generating, by the one or more processors, a sensor field of view (FOV) data set including the modified range image, the sensor FOV data set identifying whether there are occlusions in a field of view of the given sensor; providing the sensor FOV data set to at least one on-board module of the vehicle; and controlling operation of the vehicle in the autonomous driving mode according to the provided sensor FOV data set.

In one example, removing the noise includes filtering out noise values from the range image based on a last-returned result received by the given sensor. In another example, filling in the missing data points includes representing portions of the range image having the missing data points in a same way as one or more adjacent areas of the range image.

In a further example, modifying the range image includes applying a heuristic correction approach. The heuristic correction approach may include tracking one or more detected objects in the environment surrounding the vehicle over a period of time to determine how to correct perception data associated with the one or more detected objects. The perception data associated with the one or more detected objects may be corrected by filling in data holes associated with a given detected object. The perception data associated with the one or more detected objects may be corrected by interpolating missing pixels according to an adjacent boundary for the one or more detected objects.

In yet another example, generating the sensor FOV data set further includes compressing the modified range image while maintaining a specified amount of sensor resolution. Generating the sensor FOV data set may include determining whether to compress the modified range image based on an operational characteristic of the given sensor. Here, the operational characteristic may be selected from the group consisting of a sensor type, a minimum resolution threshold, and a transmission bandwidth.

In another example, the method may include providing the sensor data set to at least one on-board module includes providing the sensor data set to a planner module, wherein controlling operation of the vehicle in the autonomous driving mode includes the planner module controlling at least one of a direction or speed of the vehicle. In this case, controlling operation of the vehicle may include determining whether an occlusion exists along a particular direction in the environment surrounding the vehicle according to the sensor FOV data set, and, upon determining that the occlusion exists, modifying at least one of the direction or speed of the vehicle to account for the occlusion.

In yet another example, generating the sensor FOV data set comprises evaluating whether a maximum visible range value is closer than a physical distance of a point of interest to determine whether the point of interest is visible or occluded. And in another example, the method further includes providing the sensor FOV data set to at least one off-board module of a remote computing system.

According to another aspect of the technology, a system is configured to operate a vehicle in an autonomous driving mode. The system comprises memory and one or more processors operatively coupled to the memory. The one or more processors are configured to receive raw sensor data from one or more sensors of a perception system of the vehicle. The one or more sensors are configured to detect objects in an environment surrounding the vehicle. The processor(s) is further configured to generate a range image for a set of the raw sensor data received from a given one of the one or more sensors of the perception system, modify the range image by performing at least one of removal of noise or filling in missing data points for the set of raw sensor data, and generate a sensor field of view (FOV) data set including the modified range image. The sensor FOV data set identifies whether there are occlusions in a field of view of the given sensor. The processor(s) is further configured to store the generated sensor FOV data set in the memory, and control operation of the vehicle in the autonomous driving mode according to the stored sensor FOV data set.

In one example, removal of the noise includes filtering out noise values from the range image based on a last-returned result received by the given sensor. In another example, filling in the missing data points includes representing portions of the range image having the missing data points in a same way as one or more adjacent areas of the range image. In yet another example, modification of the range image includes application of a heuristic correction approach. And in a further example, generation of the sensor FOV data set includes a determination of whether to compress the modified range image based on an operational characteristic of the given sensor.

According to yet another aspect of the technology, a vehicle is provided that includes both the system described above and the perception system.

### BRIEF DESCRIPTION OF THE DRAWINGS

FIGS. 1A-B illustrate an example passenger-type vehicle configured for use with aspects of the technology.

FIGS. 1C-D illustrate an example cargo-type vehicle configured for use with aspects of the technology.

FIG. 2 is a block diagram of systems of an example passenger-type vehicle in accordance with aspects of the technology.

FIGS. 3A-B are block diagrams of systems of an example cargo-type vehicle in accordance with aspects of the technology.

FIG. 4 illustrates example sensor fields of view for a passenger-type vehicle in accordance with aspects of the disclosure.

FIGS. 5A-B illustrate example sensor fields of view for a cargo-type vehicle in accordance with aspects of the disclosure.

FIGS. 6A-C illustrate examples of occlusions in sensor fields of view in different driving situations.

FIGS. 7A-C illustrate examples of correcting for noise and missing sensor data in accordance with aspects of the technology.

FIGS. 7D-F illustrate an example of range image correction in accordance with aspects of the technology.

FIGS. 8A-B illustrate examples listening range scenarios in accordance with aspects of the technology.

FIGS. 9A-B illustrates an example system in accordance with aspects of the technology.

FIG. 10 illustrates an example method in accordance with aspects of the technology.

### DETAILED DESCRIPTION

Aspects of the technology gather received data from on-board sensors and compute range images for each sensor based on their received data. The data for each range image may be corrected in accordance with obtained perception information, heuristics and/or machine learning to fill gaps in the data, filter out noise, etc. Depending on the sensor type and its characteristics, the resultant corrected data may be compressed prior to packaging into a format for consumption by onboard and offboard systems. Such systems are able to evaluate the corrected data when performing driving operations, planning an upcoming route, testing driving scenarios, etc.

### Example Vehicle Systems

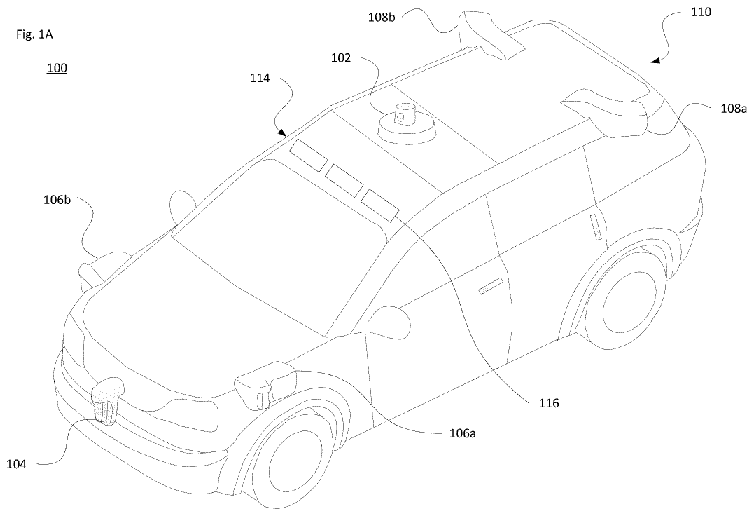

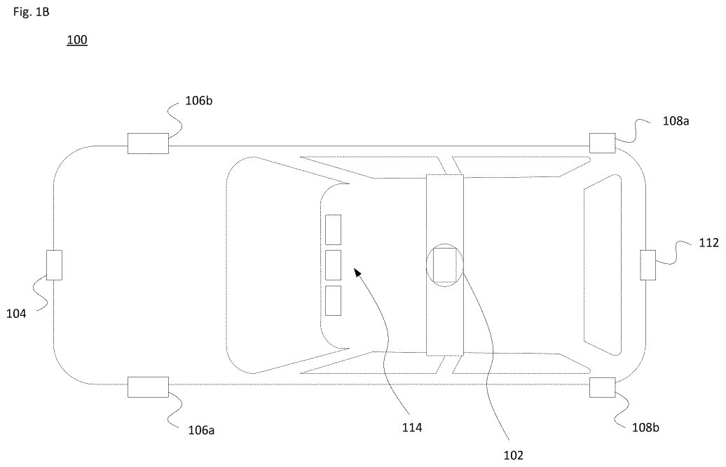

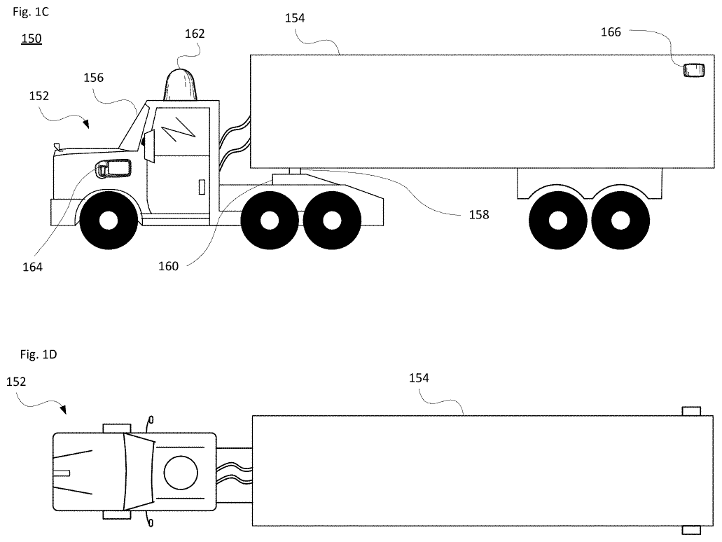

FIG. 1A illustrates a perspective view of an example passenger vehicle 100, such as a minivan, sport utility vehicle (SUV) or other vehicle. FIG. 1B illustrates a top-down view of the passenger vehicle 100. The passenger vehicle 100 may include various sensors for obtaining information about the vehicle's external environment. For instance, a roof-top housing 102 may include a lidar sensor as well as various cameras, radar units, infrared and/or acoustical sensors. Housing 104, located at the front end of vehicle 100, and housings 106a, 106b on the driver's and passenger's sides of the vehicle may each incorporate lidar, radar, camera and/or other sensors. For example, housing 106a may be located in front of the driver's side door along a quarter panel of the vehicle. As shown, the passenger vehicle 100 also includes housings 108a, 108b for radar units, lidar and/or cameras also located towards the rear roof portion of the vehicle. Additional lidar, radar units and/or cameras (not shown) may be located at other places along the vehicle 100. For instance, arrow 110 indicates that a sensor unit (112 in FIG. 1B) may be positioned along the rear of the vehicle 100, such as on or adjacent to the bumper. And arrow 114 indicates a series of sensor units 116 arranged along a forward-facing direction of the vehicle. In some examples, the passenger vehicle 100 also may include various sensors for obtaining information about the vehicle's interior spaces (not shown).

FIGS. 1C-D illustrate an example cargo vehicle 150, such as a tractor-trailer truck. The truck may include, e.g., a single, double or triple trailer, or may be another medium or heavy duty truck such as in commercial weight classes 4 through 8. As shown, the truck includes a tractor unit 152 and a single cargo unit or trailer 154. The trailer 154 may be fully enclosed, open such as a flat bed, or partially open depending on the type of cargo to be transported. In this example, the tractor unit 152 includes the engine and steering systems (not shown) and a cab 156 for a driver and any passengers. In a fully autonomous arrangement, the cab 156 may not be equipped with seats or manual driving components, since no person may be necessary.

The trailer 154 includes a hitching point, known as a kingpin, 158. The kingpin 158 is typically formed as a solid steel shaft, which is configured to pivotally attach to the tractor unit 152. In particular, the kingpin 158 attaches to a trailer coupling 160, known as a fifth-wheel, that is mounted rearward of the cab. For a double or triple tractor-trailer, the second and/or third trailers may have simple hitch connections to the leading trailer. Or, alternatively, each trailer may have its own kingpin. In this case, at least the first and second trailers could include a fifth-wheel type structure arranged to couple to the next trailer.

As shown, the tractor may have one or more sensor units 162, 164 disposed therealong. For instance, one or more sensor units 162 may be disposed on a roof or top portion of the cab 156, and one or more side sensor units 164 may be disposed on left and/or right sides of the cab 156. Sensor units may also be located along other regions of the cab 106, such as along the front bumper or hood area, in the rear of the cab, adjacent to the fifth-wheel, underneath the chassis, etc. The trailer 154 may also have one or more sensor units 166 disposed therealong, for instance along a side panel, front, rear, roof and/or undercarriage of the trailer 154.

By way of example, each sensor unit may include one or more sensors, such as lidar, radar, camera (e.g., optical or infrared), acoustical (e.g., microphone or sonar-type sensor), inertial (e.g., accelerometer, gyroscope, etc.) or other sensors (e.g., positioning sensors such as GPS sensors). While certain aspects of the disclosure may be particularly useful in connection with specific types of vehicles, the vehicle may be any type of vehicle including, but not limited to, cars, trucks, motorcycles, buses, recreational vehicles, etc.

There are different degrees of autonomy that may occur for a vehicle operating in a partially or fully autonomous driving mode. The U.S. National Highway Traffic Safety Administration and the Society of Automotive Engineers have identified different levels to indicate how much, or how little, the vehicle controls the driving. For instance, Level 0 has no automation and the driver makes all driving-related decisions. The lowest semi-autonomous mode, Level 1, includes some drive assistance such as cruise control. Level 2 has partial automation of certain driving operations, while Level 3 involves conditional automation that can enable a person in the driver's seat to take control as warranted. In contrast, Level 4 is a high automation level where the vehicle is able to drive without assistance in select conditions. And Level 5 is a fully autonomous mode in which the vehicle is able to drive without assistance in all situations. The architectures, components, systems and methods described herein can function in any of the semi or fully-autonomous modes, e.g., Levels 1-5, which are referred to herein as autonomous driving modes. Thus, reference to an autonomous driving mode includes both partial and full autonomy.

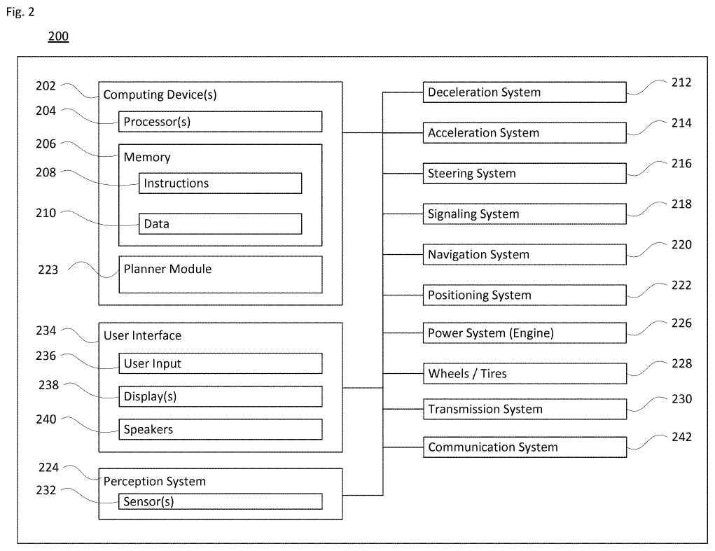

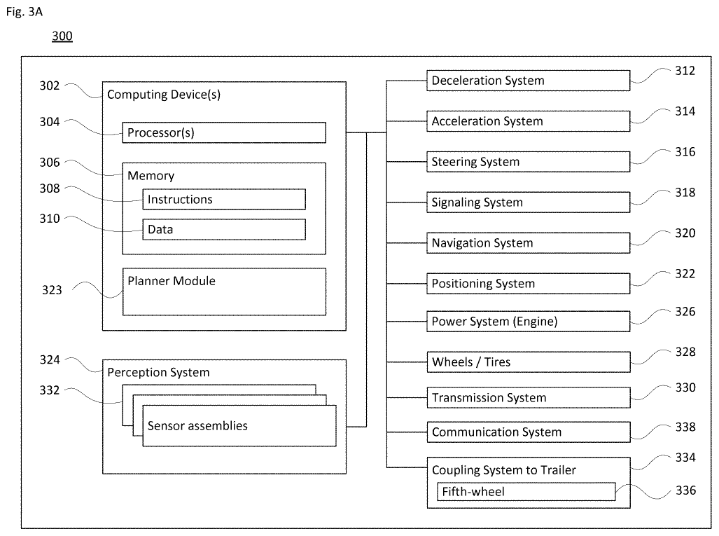

FIG. 2 illustrates a block diagram 200 with various components and systems of an exemplary vehicle, such as passenger vehicle 100, to operate in an autonomous driving mode. As shown, the block diagram 200 includes one or more computing devices 202, such as computing devices containing one or more processors 204, memory 206 and other components typically present in general purpose computing devices. The memory 206 stores information accessible by the one or more processors 204, including instructions 208 and data 210 that may be executed or otherwise used by the processor(s) 204. The computing system may control overall operation of the vehicle when operating in an autonomous driving mode.

The memory 206 stores information accessible by the processors 204, including instructions 208 and data 210 that may be executed or otherwise used by the processors 204. The memory 206 may be of any type capable of storing information accessible by the processor, including a computing device-readable medium. The memory is a non-transitory medium such as a hard-drive, memory card, optical disk, solid-state, etc. Systems may include different combinations of the foregoing, whereby different portions of the instructions and data are stored on different types of media.

The instructions 208 may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance. The data 210 may be retrieved, stored or modified by one or more processors 204 in accordance with the instructions 208. In one example, some or all of the memory 206 may be an event data recorder or other secure data storage system configured to store vehicle diagnostics and/or detected sensor data, which may be on board the vehicle or remote, depending on the implementation.

The processors 204 may be any conventional processors, such as commercially available CPUs. Alternatively, each processor may be a dedicated device such as an ASIC or other hardware-based processor. Although FIG. 2 functionally illustrates the processors, memory, and other elements of computing devices 202 as being within the same block, such devices may actually include multiple processors, computing devices, or memories that may or may not be stored within the same physical housing. Similarly, the memory 206 may be a hard drive or other storage media located in a housing different from that of the processor(s) 204. Accordingly, references to a processor or computing device will be understood to include references to a collection of processors or computing devices or memories that may or may not operate in parallel.

In one example, the computing devices 202 may form an autonomous driving computing system incorporated into vehicle 100. The autonomous driving computing system may capable of communicating with various components of the vehicle. For example, the computing devices 202 may be in communication with various systems of the vehicle, including a driving system including a deceleration system 212 (for controlling braking of the vehicle), acceleration system 214 (for controlling acceleration of the vehicle), steering system 216 (for controlling the orientation of the wheels and direction of the vehicle), signaling system 218 (for controlling turn signals), navigation system 220 (for navigating the vehicle to a location or around objects) and a positioning system 222 (for determining the position of the vehicle, e.g., including the vehicle's pose). The autonomous driving computing system may employ a planner module 223, in accordance with the navigation system 220, the positioning system 222 and/or other components of the system, e.g., for determining a route from a starting point to a destination or for making modifications to various driving aspects in view of current or expected traction conditions.

The computing devices 202 are also operatively coupled to a perception system 224 (for detecting objects in the vehicle's environment), a power system 226 (for example, a battery and/or gas or diesel powered engine) and a transmission system 230 in order to control the movement, speed, etc., of the vehicle in accordance with the instructions 208 of memory 206 in an autonomous driving mode which does not require or need continuous or periodic input from a passenger of the vehicle. Some or all of the wheels/tires 228 are coupled to the transmission system 230, and the computing devices 202 may be able to receive information about tire pressure, balance and other factors that may impact driving in an autonomous mode.

The computing devices 202 may control the direction and speed of the vehicle, e.g., via the planner module 223, by controlling various components. By way of example, computing devices 202 may navigate the vehicle to a destination location completely autonomously using data from the map information and navigation system 220. Computing devices 202 may use the positioning system 222 to determine the vehicle's location and the perception system 224 to detect and respond to objects when needed to reach the location safely. In order to do so, computing devices 202 may cause the vehicle to accelerate (e.g., by increasing fuel or other energy provided to the engine by acceleration system 214), decelerate (e.g., by decreasing the fuel supplied to the engine, changing gears, and/or by applying brakes by deceleration system 212), change direction (e.g., by turning the front or other wheels of vehicle 100 by steering system 216), and signal such changes (e.g., by lighting turn signals of signaling system 218). Thus, the acceleration system 214 and deceleration system 212 may be a part of a drivetrain or other type of transmission system 230 that includes various components between an engine of the vehicle and the wheels of the vehicle. Again, by controlling these systems, computing devices 202 may also control the transmission system 230 of the vehicle in order to maneuver the vehicle autonomously.

Navigation system 220 may be used by computing devices 202 in order to determine and follow a route to a location. In this regard, the navigation system 220 and/or memory 206 may store map information, e.g., highly detailed maps that computing devices 202 can use to navigate or control the vehicle. As an example, these maps may identify the shape and elevation of roadways, lane markers, intersections, crosswalks, speed limits, traffic signal lights, buildings, signs, real time traffic information, vegetation, or other such objects and information. The lane markers may include features such as solid or broken double or single lane lines, solid or broken lane lines, reflectors, etc. A given lane may be associated with left and/or right lane lines or other lane markers that define the boundary of the lane. Thus, most lanes may be bounded by a left edge of one lane line and a right edge of another lane line.

The perception system 224 includes sensors 232 for detecting objects external to the vehicle. The detected objects may be other vehicles, obstacles in the roadway, traffic signals, signs, trees, etc. The sensors may 232 may also detect certain aspects of weather conditions, such as snow, rain or water spray, or puddles, ice or other materials on the roadway.

By way of example only, the perception system 224 may include one or more light detection and ranging (lidar) sensors, radar units, cameras (e.g., optical imaging devices, with or without a neutral-density filter (ND) filter), positioning sensors (e.g., gyroscopes, accelerometers and/or other inertial components), infrared sensors, acoustical sensors (e.g., microphones or sonar transducers), and/or any other detection devices that record data which may be processed by computing devices 202. Such sensors of the perception system 224 may detect objects outside of the vehicle and their characteristics such as location, orientation, size, shape, type (for instance, vehicle, pedestrian, bicyclist, etc.), heading, speed of movement relative to the vehicle, etc. The perception system 224 may also include other sensors within the vehicle to detect objects and conditions within the vehicle, such as in the passenger compartment. For instance, such sensors may detect, e.g., one or more persons, pets, packages, etc., as well as conditions within and/or outside the vehicle such as temperature, humidity, etc. Still further sensors 232 of the perception system 224 may measure the rate of rotation of the wheels 228, an amount or a type of braking by the deceleration system 212, and other factors associated with the equipment of the vehicle itself.

As discussed further below, the raw data obtained by the sensors can be processed by the perception system 224 and/or sent for further processing to the computing devices 202 periodically or continuously as the data is generated by the perception system 224. Computing devices 202 may use the positioning system 222 to determine the vehicle's location and perception system 224 to detect and respond to objects when needed to reach the location safely, e.g., via adjustments made by planner module 223, including adjustments in operation to deal with occlusions and other issues. In addition, the computing devices 202 may perform calibration of individual sensors, all sensors in a particular sensor assembly, or between sensors in different sensor assemblies or other physical housings.

As illustrated in FIGS. 1A-B, certain sensors of the perception system 224 may be incorporated into one or more sensor assemblies or housings. In one example, these may be integrated into the side-view mirrors on the vehicle. In another example, other sensors may be part of the roof-top housing 102, or other sensor housings or units 106a,b, 108a,b, 112 and/or 116. The computing devices 202 may communicate with the sensor assemblies located on or otherwise distributed along the vehicle. Each assembly may have one or more types of sensors such as those described above.

Returning to FIG. 2, computing devices 202 may include all of the components normally used in connection with a computing device such as the processor and memory described above as well as a user interface subsystem 234. The user interface subsystem 234 may include one or more user inputs 236 (e.g., a mouse, keyboard, touch screen and/or microphone) and one or more display devices 238 (e.g., a monitor having a screen or any other electrical device that is operable to display information). In this regard, an internal electronic display may be located within a cabin of the vehicle (not shown) and may be used by computing devices 202 to provide information to passengers within the vehicle. Other output devices, such as speaker(s) 240 may also be located within the passenger vehicle.

The passenger vehicle also includes a communication system 242. For instance, the communication system 242 may also include one or more wireless configurations to facilitate communication with other computing devices, such as passenger computing devices within the vehicle, computing devices external to the vehicle such as in another nearby vehicle on the roadway, and/or a remote server system. The network connections may include short range communication protocols such as Bluetooth™, Bluetooth™ low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

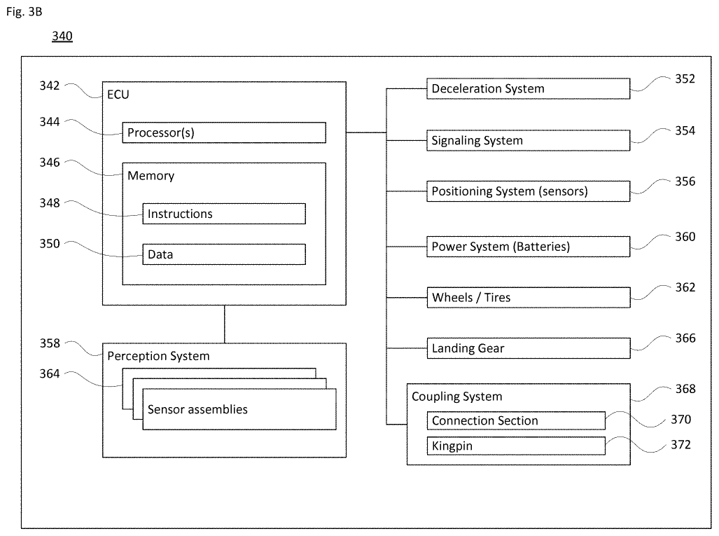

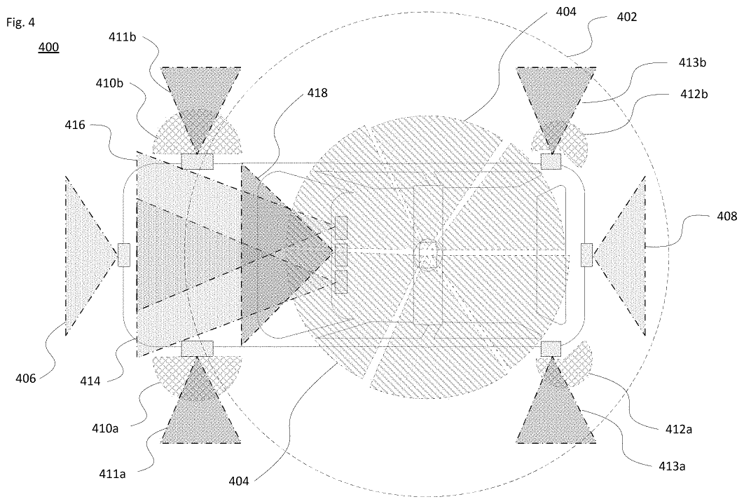

FIG. 3A illustrates a block diagram 300 with various components and systems of a vehicle, e.g., vehicle 150 of FIG. 1C. By way of example, the vehicle may be a truck, farm equipment or construction equipment, configured to operate in one or more autonomous modes of operation. As shown in the block diagram 300, the vehicle includes a control system of one or more computing devices, such as computing devices 302 containing one or more processors 304, memory 306 and other components similar or equivalent to components 202, 204 and 206 discussed above with regard to FIG. 2. The control system may constitute an electronic control unit (ECU) of a tractor unit of a cargo vehicle. As with instructions 208, the instructions 308 may be any set of instructions to be executed directly (such as machine code) or indirectly (such as scripts) by the processor. Similarly, the data 310 may be retrieved, stored or modified by one or more processors 304 in accordance with the instructions 308.

In one example, the computing devices 302 may form an autonomous driving computing system incorporated into vehicle 150. Similar to the arrangement discussed above regarding FIG. 2, the autonomous driving computing system of block diagram 300 may capable of communicating with various components of the vehicle in order to perform route planning and driving operations. For example, the computing devices 302 may be in communication with various systems of the vehicle, such as a driving system including a deceleration system 312, acceleration system 314, steering system 316, signaling system 318, navigation system 320 and a positioning system 322, each of which may function as discussed above regarding FIG. 2.

The computing devices 302 are also operatively coupled to a perception system 324, a power system 326 and a transmission system 330. Some or all of the wheels/tires 228 are coupled to the transmission system 230, and the computing devices 202 may be able to receive information about tire pressure, balance, rotation rate and other factors that may impact driving in an autonomous mode. As with computing devices 202, the computing devices 302 may control the direction and speed of the vehicle by controlling various components. By way of example, computing devices 302 may navigate the vehicle to a destination location completely autonomously using data from the map information and navigation system 320. Computing devices 302 may employ a planner module 323, in conjunction with the positioning system 322, the perception system 324 and other subsystems to detect and respond to objects when needed to reach the location safely, similar to the manner described above for FIG. 2.

Similar to perception system 224, the perception system 324 also includes one or more sensors or other components such as those described above for detecting objects external to the vehicle, objects or conditions internal to the vehicle, and/or operation of certain vehicle equipment such as the wheels and deceleration system 312. For instance, as indicated in FIG. 3A the perception system 324 includes one or more sensor assemblies 332. Each sensor assembly 232 includes one or more sensors. In one example, the sensor assemblies 332 may be arranged as sensor towers integrated into the side-view mirrors on the truck, farm equipment, construction equipment or the like. Sensor assemblies 332 may also be positioned at different locations on the tractor unit 152 or on the trailer 154, as noted above with regard to FIGS. 1C-D. The computing devices 302 may communicate with the sensor assemblies located on both the tractor unit 152 and the trailer 154. Each assembly may have one or more types of sensors such as those described above.

Also shown in FIG. 3A is a coupling system 334 for connectivity between the tractor unit and the trailer. The coupling system 334 may include one or more power and/or pneumatic connections (not shown), and a fifth-wheel 336 at the tractor unit for connection to the kingpin at the trailer. A communication system 338, equivalent to communication system 242, is also shown as part of vehicle system 300.

FIG. 3B illustrates an example block diagram 340 of systems of the trailer, such as trailer 154 of FIGS. 1C-D. As shown, the system includes an ECU 342 of one or more computing devices, such as computing devices containing one or more processors 344, memory 346 and other components typically present in general purpose computing devices. The memory 346 stores information accessible by the one or more processors 344, including instructions 348 and data 350 that may be executed or otherwise used by the processor(s) 344. The descriptions of the processors, memory, instructions and data from FIGS. 2 and 3A apply to these elements of FIG. 3B.

The ECU 342 is configured to receive information and control signals from the trailer unit. The on-board processors 344 of the ECU 342 may communicate with various systems of the trailer, including a deceleration system 352, signaling system 254, and a positioning system 356. The ECU 342 may also be operatively coupled to a perception system 358 with one or more sensors for detecting objects in the trailer's environment and a power system 260 (for example, a battery power supply) to provide power to local components. Some or all of the wheels/tires 362 of the trailer may be coupled to the deceleration system 352, and the processors 344 may be able to receive information about tire pressure, balance, wheel speed and other factors that may impact driving in an autonomous mode, and to relay that information to the processing system of the tractor unit. The deceleration system 352, signaling system 354, positioning system 356, perception system 358, power system 360 and wheels/tires 362 may operate in a manner such as described above with regard to FIGS. 2 and 3A.

The trailer also includes a set of landing gear 366, as well as a coupling system 368. The landing gear provide a support structure for the trailer when decoupled from the tractor unit. The coupling system 368, which may be a part of coupling system 334, provides connectivity between the trailer and the tractor unit. Thus, the coupling system 368 may include a connection section 370 (e.g., for power and/or pneumatic links). The coupling system also includes a kingpin 372 configured for connectivity with the fifth-wheel of the tractor unit.

### Example Implementations

In view of the structures and configurations described above and illustrated in the figures, various aspects will now be described in accordance with aspects of the technology.

Sensors, such as long and short range lidars, radar sensors, cameras or other imaging devices, etc., are used in self-driving vehicles (SDVs) or other vehicles that are configured to operate in an autonomous driving mode to detect objects and conditions in the environment around the vehicle. Each sensor may have a particular field of view (FOV) including a maximum range, and for some sensors a horizontal resolution and a vertical resolution. For instance, a panoramic lidar sensor may have a maximum range on the order of 70-100 meters, a vertical resolution of between 0.1°−0.3°, and a horizontal resolution of between 0.1°-0.4°, or more or less. A directional lidar sensor, for example to provide information about a front, rear or side area of the vehicle, may have a maximum range on the order of 100-300 meters, a vertical resolution of between of between 0.05°−0.2°, and a horizontal resolution of between 0.01°-0.03°, or more or less.

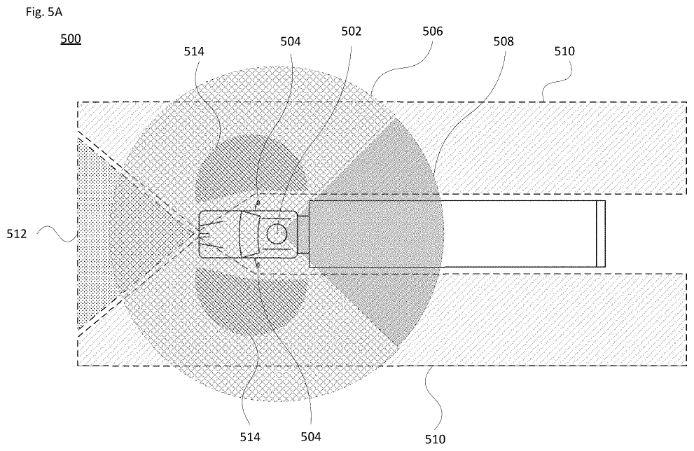

FIG. 4 provides one example 400 of sensor fields of view relating to the sensors illustrated in FIG. 1B. Here, should the roof-top housing 102 include a lidar sensor as well as various cameras, radar units, infrared and/or acoustical sensors, each of those sensors may have a different field of view. Thus, as shown, the lidar sensor may provide a 360° FOV 402, while cameras arranged within the housing 102 may have individual FOVs 404. A sensor within housing 104 at the front end of the vehicle has a forward facing FOV 406, while a sensor within housing 112 at the rear end has a rearward facing FOV 408. The housings 106a, 106b on the driver's and passenger's sides of the vehicle may each incorporate lidar, radar, camera and/or other sensors. For instance, lidars within housings 106a and 106b may have a respective FOV 410a or 410b, while radar units or other sensors within housings 106a and 106b may have a respective FOV 411a or 411b. Similarly, sensors within housings 108a, 108b located towards the rear roof portion of the vehicle each have a respective FOV. For instance, lidars within housings 108a and 108b may have a respective FOV 412a or 412b, while radar units or other sensors within housings 108a and 108b may have a respective FOV 413a or 413b. And the series of sensor units 116 arranged along a forward-facing direction of the vehicle may have respective FOVs 414, 416 and 418. Each of these fields of view is merely exemplary and not to scale in terms of coverage range.

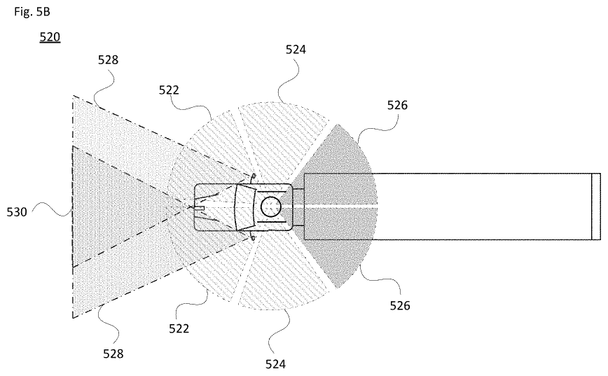

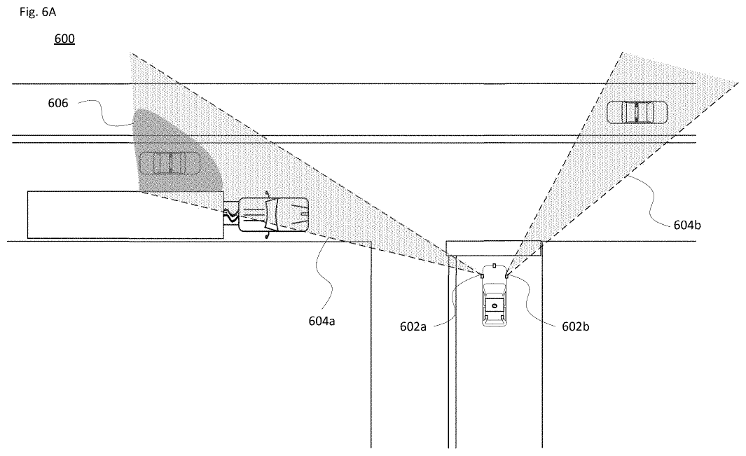

Examples of lidar, camera and radar sensors and their fields of view for a cargo-type vehicle (e.g., vehicle 150 of FIGS. 1C-D) are shown in FIGS. 5A and 5B. In example 500 of FIG. 5A, one or more lidar units may be located in rooftop sensor housing 502, with other lidar units in perimeter sensor housings 504. In particular, the rooftop sensor housing 502 may be configured to provide a 360° FOV. A pair of sensor housings 504 may be located on either side of the tractor unit cab, for instance integrated into a side view mirror assembly or along a side door or quarter panel of the cab. In one scenario, long range lidars may be located along a top or upper area of the sensor housings 502 and 504. The long range lidar may be configured to see over the hood of the vehicle. And short range lidars may be located in other portions of the sensor housings 502 and 504. The short range lidars may be used by the perception system to determine whether an object such as another vehicle, pedestrian, bicyclist, etc. is next to the front or side of the vehicle and take that information into account when determining how to drive or turn. Both types of lidars may be co-located in the housing, for instance aligned along a common vertical axis.

As illustrated in FIG. 5A, the lidar(s) in the rooftop sensor housing 502 may have a FOV 506. Here, as shown by region 508, the trailer or other articulating portion of the vehicle may provide signal returns, and may partially or fully block a rearward view of the external environment. Long range lidars on the left and right sides of the tractor unit have FOV 510. These can encompass significant areas along the sides and front of the vehicle. As shown, there may be an overlap region 512 of their fields of view in front of the vehicle. The overlap region 512 provides the perception system with additional or information about a very important region that is directly in front of the tractor unit. This redundancy also has a safety aspect. Should one of the long range lidar sensors suffer degradation in performance, the redundancy would still allow for operation in an autonomous mode. Short range Lidars on the left and right sides have smaller FOV 514. A space is shown between different fields of view for clarity in the drawing; however in actuality there may be no break in the coverage. The specific placements of the sensor assemblies and fields of view is merely exemplary, and may different depending on, e.g., the type of vehicle, the size of the vehicle, FOV requirements, etc.

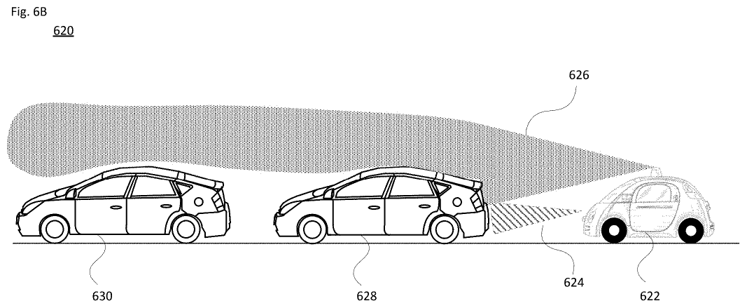

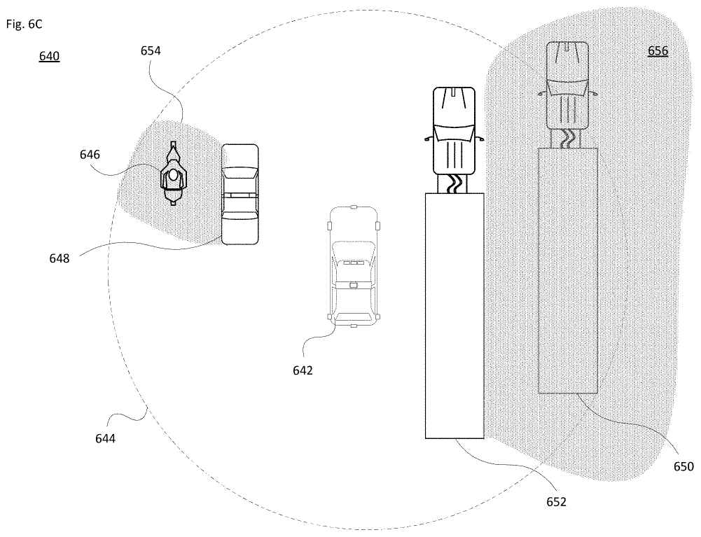

FIG. 5B illustrates an example configuration 520 for either (or both) of radar and camera sensors in a rooftop housing and on both sides of a tractor-trailer, such as vehicle 150 of FIGS. 1C-D. Here, there may be multiple radar and/or camera sensors in each of the sensor housings 502 and 504 of FIG. 6A. As shown, there may be sensors in the rooftop housing with front FOV 522, side FOV 524 and rear FOV 526. As with region 508, the trailer may impact the ability of the sensor to detect objects behind the vehicle. Sensors in the sensor housings 504 may have forward facing FOV 528 (and side and/or rear fields of view as well). As with the lidars discussed above with respect to FIG. 5A, the sensors of FIG. 5B may be arranged so that the adjoining fields of view overlap, such as shown by overlapping region 530. The overlap regions here similarly can provide redundancy and have the same benefits should one sensor suffer degradation in performance. The specific placements of the sensor assemblies and fields of view is merely exemplary, and may different depending on, e.g., the type of vehicle, the size of the vehicle, FOV requirements, etc.

As shown by regions 508 and 526 of FIGS. 5A and 5B, a particular sensor's ability to detect an object in the vehicle's environment can be limited by occlusions. In these examples, the occlusions may be due to a portion of the vehicle itself, such as the trailer. In other examples, occlusions may be caused by other vehicles, buildings, foliage, etc. Such occlusions may obscure the presence of objects that are farther away that the intervening object, or may impact the ability of the vehicle's computer system from determining types of detected objects.

### Example Scenarios

It is important for the on-board computer system to know whether there is an occlusion, because knowing this can impact driving or route planning decisions, as well as off-line training and analysis. For example, in the top-down view 600 of FIG. 6A, a vehicle operating in an autonomous driving mode may be at a T-shaped intersection waiting to make an unprotected left-hand turn. The on-board sensors may not detect any vehicles approaching from the left side. But this may be due to the fact that there is an occlusion (e.g., a cargo truck parked on the side of the street) rather than there actually being no oncoming vehicles. In particular, side sensors 602a and 602b may be arranged to have corresponding FOVs shown by respective dashed regions 604a and 604b. As illustrated by shaded region 606, the parked cargo truck may partially or fully obscure an oncoming car.

FIG. 6B illustrates another scenario 620 in which vehicle 622 uses directional forward-facing sensors to detect the presence of other vehicles. As shown, the sensors have respective FOVs 624 and 626 to detect objects in front of vehicle 622. In this example, the sensors may be, e.g., lidar, radar, image and/or acoustical sensors. Here, a first vehicle 628 may be between vehicle 622 and a second vehicle 630. The intervening first vehicle 268 may occlude the second vehicle 630 from the FOVs 624 and/or 626.

And FIG. 6C illustrates yet another scenario 640, in which vehicle 642 uses a sensor, e.g., lidar or radar, to provide a 360° FOV, as shown by the circular dashed line 644. Here, a motorcycle 646 approaching in the opposite direction may be obscured by a sedan or other passenger vehicle 648, while a truck 650 traveling in the same direction may be obscured by another truck 652 in between it and the vehicle 642, as shown by shaded regions 654 and 656, respectively.

In all of these situations, the lack of information about an object in the surrounding environment may lead to one driving decision, whereas if the vehicle were aware of a possible occlusion it might lead to a different driving decision. In order to address such issues, according to aspects of the technology visibility and occlusion information is determined based on data received from the perception system's sensors, providing a sensor FOV result that can be used by different onboard and offboard systems for real-time vehicle operation, modeling, planning and other processes.

A range image computed from raw (unprocessed) received sensor data is used to capture the visibility information. For instance, this information can be stored as a matrix of values, where each value is associated with a point (pixel) in the range image. According to one example, the range image can be presented visually to a user, where different matrix values can be associated with different colors or greyscale shading. In the case of a lidar sensor, each pixel stored in the range image represents the maximum range the laser shot can see along a certain azimuth and inclination angle (view angle). For any 3D location whose visibility is being evaluated, the pixel at which the 3D location's laser shot falls into can be identified and the ranges (e.g., stored maximum visible range versus physical distance from the vehicle to the 3D location) can be compared. If the stored maximum visible range value is closer than the physical distance, then the 3D point is considered to be not visible, because there is a closer occlusion along this view angle. In contrast, if the stored maximum visible range value is at least the same as the physical distance, then the 3D point is considered to be visible (not occluded). A range image may be computed for each sensor in the vehicle's perception system.

The range image may include noise and there may be missing returns, e.g., no received data point for a particular emitted laser beam. This can result in an impairment to visibility. Impairments to visibility may reduce the maximum detection range of objects with the same reflectivity, so that issue may be factored into processing of the range image. Examples impairments include but are not limited to sun blinding, materials on the sensor aperture such as raindrops or leaves, atmospheric effects such as fog or heavy rain, dust clouds, exhaust, etc.

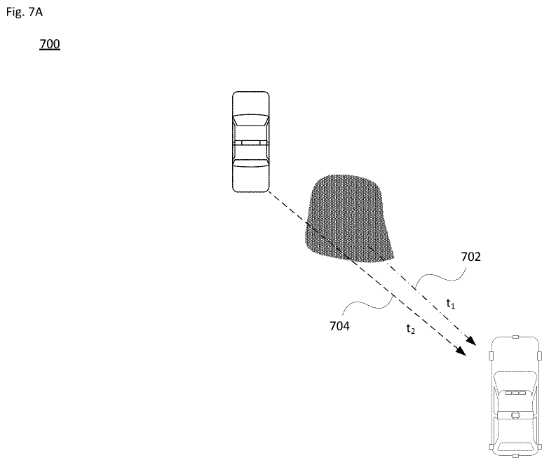

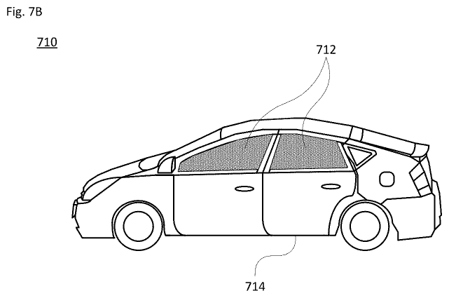

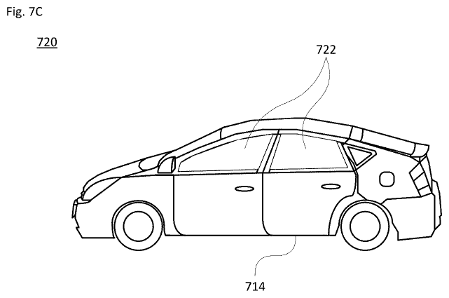

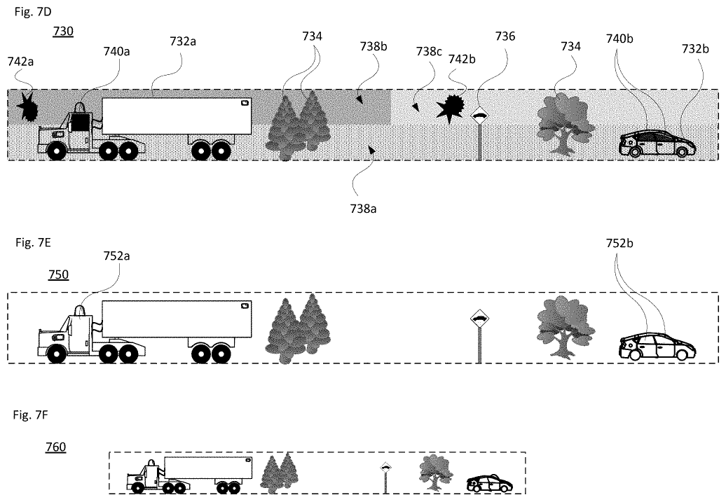

The range image data may be corrected using information obtained by the vehicle's perception system, generating a sensor field of view (FOV) data set. For instance, noise can be filtered out and holes in the data can be filled in. In one example, noise may be corrected by using information from a last-returned result (e.g., laser shot reflection) rather than from a first-returned result or other earlier returned result. This is because a given sensor may receive multiple returns from one emission (e.g., one shot of a laser). For example, as shown in scenario 700 of FIG. 7A, a first return 702 may come from the dust in the air, being received at a first point in time (t₁), while a second return 704 is received at a slightly later time (t₂) from a car located behind the dust. Here, the system uses the last received return from time t₂ (e.g., the furthest the laser can see along that shot). In another example 710 of FIG. 7B, windows 712 of vehicle 714 may appear as holes in the range image, because a laser beam will not reflect off of the glass in the same way that it would reflect off of other parts of the vehicle. Filling in the window “holes” may include representing those portions of the range image in the same way as adjacent areas of the detected vehicle. FIG. 7C illustrates a view 720 in which the window holes have been filled in as shown by regions 722.

FIGS. 7D-F illustrate one example of correcting or otherwise modifying the range image to, e.g., filter out noise and fill in holes associated with one or more objects. In particular, FIG. 7D illustrates a raw range image 730 that includes objects such as vehicles 732a and 732b, vegetation 734 and signage 736. Different portions of the raw range image 730 may also include artifacts. For instance, portion 738a includes a region closer to ground level and may be affected by backscatter from ground returns. Portion 738b may be an unobstructed portion of the sky, whereas portion 738c may be an obstructed portion of the sky, for example due to clouds, sun glare, building or other objects, and so this portion 738c may have a different appearance than portion 738b. Also shown in this example is that the windows 740a and 740b of respective vehicles 732a and 732b may appear as holes. In addition, artifacts such as artifacts 742a and 742b may appear in different portions of the raw range image.

FIG. 7E illustrates a processed range image 750. Here, by way of example the holes associated with the vehicles' windows have been filled in as shown by 752a and 752b, so that the windows appear the same as other portions of the vehicles. Also, artifacts such as missing pixels in the different portions of the raw range image have been corrected. The processed (modified) range image 750 may be stored as a sensor FOV data set, for example as the matrix in which certain pixel values have been changed according to corrections made to the range image.

FIG. 7F illustrates a compressed range image 760. As discussed further below, the modified range image may be compressed depending on the size of the set associated with the particular sensor.

Heuristic or learning-based approaches can be employed to correct the range image. A heuristic approach can identify large portions of the image that are sky (e.g., located along a top region of the image) or ground (e.g., located along a bottom region of the image. This approach can track perception-detected objects to help determine how to deal with specific areas or conditions. For instance, if the perception system determines that an object is a vehicle, the window “holes” can be automatically filled in as part of the vehicle. Other missing pixels can be interpolated (e.g., inward from an adjacent boundary) using various image processing techniques, such as constant color analysis, horizontal interpolation or extrapolation, or variational inpainting. In another example, exhaust may be detected in some but not all of the laser returns. Based on this, the system could determine that the exhaust is something that can be ignored.

Additional heuristics involve objects at or near the minimum or maximum range of the sensor. For instance, if an object is closer than the minimum range of a sensor, the sensor will not be able to detect this object (thus, another type of hole in range image); however, the object would block the view of the sensor and create an occlusion. Here, the system may search for holes associated with a particular region of the image, such as the bottom of the image, and consider those having the minimum range of the sensor.

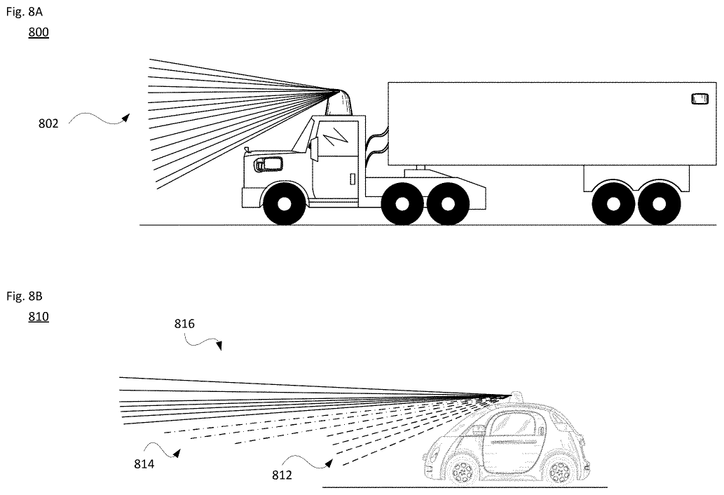

With regard to the maximum sensor range of, e.g., a laser, not all laser shots are the same. For instance, some laser shots are designed to see farther away while some are designed to see closer. How far a shot is designed to see is called maximum listening range. FIGS. 8A and 8B illustrate two example scenarios 800 and 810, respectively. In scenario 800 of FIG. 8A, the truck may emit a set of laser shots 802, where each shot has a different azimuth. In this case, each shot may be selected to have the same listening range. In contrast, as shown in scenario 810 of FIG. 8B, a set of one or more laser shots 812 represented by dashed lines has a first listening range, another set of shots 814 represented by dash-dot lines has a second listening range, and a third set of shots 816 represented by solid lines has a third listening range. In this example, set 812 has a close listening range (e.g., 2-10 meters) because these shots are arranged to point nearby toward the ground. The set 814 may have an intermediate listening range (e.g., 10-30 meters), for instance to detect nearby vehicles. And the set 816 may have an extended listening range (e.g., 30-200 meters) for objects that are far away. In this approach, the system can save resources (e.g., time). Thus, if the shot can only reach a maximum of X meters, then the final range to fill this pixel cannot be bigger than X meters. Therefore, the system can take the minimum of the estimated range and maximum listening range, or min (estimated range, maximum listening range) to fill in a particular pixel.

In an example learning-based approach, the problem to be solved is to fill in missing parts of the obtained sensor data. For a machine leaning method, a set of training data can be created by removing some of the actually captured laser shots in collected data to obtain a training range image. The removed parts are the ground truth data. The machine learning system learns how to fill in the removed parts using those ground truth. Once trained, the system is then employed with real raw sensor data. For example, in an original range image, some subset of pixels would be randomly removed. The training range image is missing the removed pixels, and those pixels are the ground truth. The system trains a net to learn how to fill those intentionally removed pixel from the entire image. This net can now be applied on real holes in “live” sensor data, and it will try to fill those holes with the knowledge it has learned.

Regardless of the approaches used to correct or otherwise modify the range image, the resultant sensor FOV data set with the modified range image may be compressed depending on the size of the set. The decision on whether to compress may be made on a sensor by sensor basis, a minimum resolution threshold requirement, a transmission bandwidth requirement (e.g., for transmission to a remote system) and/or other factors. For instance, a sensor FOV data set from a panoramic sensor (e.g., 360° lidar sensor) may be compressed, while data from a directional sensor may not need to be compressed. Various image processing techniques can be used, so long as a specified amount of resolution (e.g., within 1°) is maintained. By way of example, lossless image compression algorithms such as PNG compression may be employed

Then, whether compressed or not, the sensor FOV information for one or more sensors is made available to onboard and/or remote systems. The onboard systems may include the planner module and the perception system. In one example, the planner module employs the sensor FOV information to control the direction and speed of the vehicle. Information from different sensor FOV data sets associated with different sensors may be combined or evaluated individually by the planner module or other system as needed.

When an occlusion is identified as discussed above, objects detected by the perception system alone may not be sufficient for the planner module to make an operating decision, such as whether to start an unprotected left turn. If there is an occlusion, it may be hard for the system to tell whether there is no object at all, or whether there might be an oncoming vehicle that has not been flagged by the perception system due to the occlusion. Here, the sensor FOV information is used by the planner module to indicate there is an occlusion. For example, the planner module would consider the possibility of there being an oncoming occluded object, which may impact how the vehicle behaves. By way of example, this could occur in a situation where the vehicle is making an unprotected left turn. For instance, the planner module could query the system to see if a particular region in the external environment around the vehicle is visible or occluded. This can be done by checking the corresponding pixels covering that region in the range image representation in the sensor FOV. If not visible, that would indicate an occlusion in the region. Here, the planner module may speculate that there is another object in the occluded area (e.g., an oncoming vehicle). In this situation, the planner module may cause the vehicle to slowly pull out in order to reduce the impact of the occlusion by allowing its sensors to obtain additional information regarding the environment.

Another example includes lowering the speed of the vehicle if the vehicle is in a region that has lowered visibility, e.g., due to fog, dust or other environmental conditions. A further example involves remembering the presence of objects that were visible before, but later entered an occlusion. For instance, another car may drive through a region not visible to the self-driving vehicle. And yet another example might involve deciding that a region of particular interest cannot be guaranteed to be fully clear because it is occluded, e.g., a crosswalk.

Offboard systems may use the sensor FOV information to perform autonomous simulations based on real-world or man-made scenarios, or metric analysis to evaluate system metrics that might be impacted by visibility/occlusion. This information may be used in model training. It can also be shared across a fleet of vehicles to enhance the perception and route planning for those vehicles.

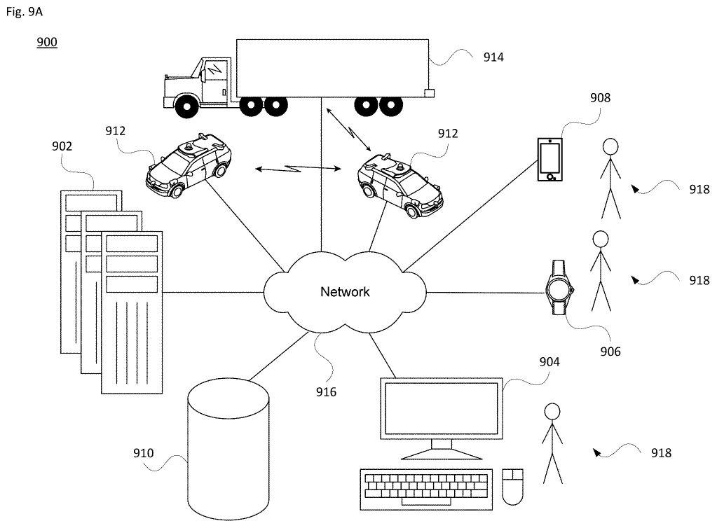

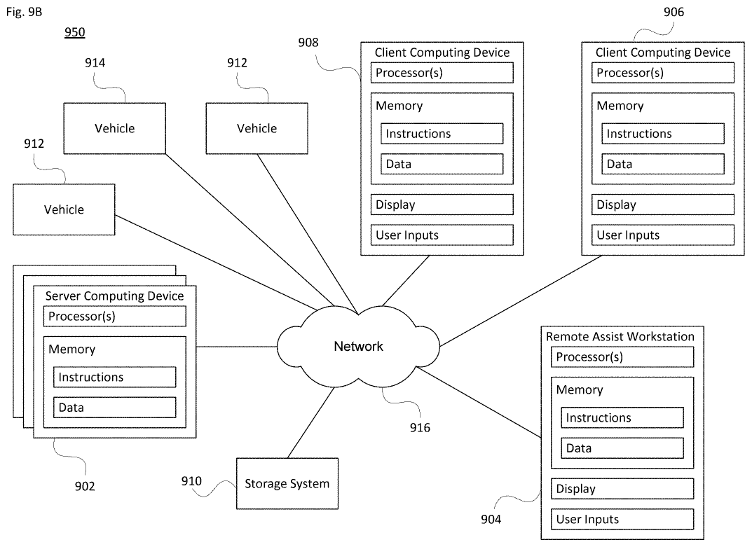

One such arrangement is shown in FIGS. 9A and 9B. In particular, FIGS. 9A and 9B are pictorial and functional diagrams, respectively, of an example system 900 that includes a plurality of computing devices 902, 904, 906, 908 and a storage system 910 connected via a network 916. System 900 also includes vehicles 912 and 914, which may be configured the same as or similarly to vehicles 100 and 150 of FIGS. 1A-B and 1C-D, respectively. Vehicles 912 and/or vehicles 914 may be part of a fleet of vehicles. Although only a few vehicles and computing devices are depicted for simplicity, a typical system may include significantly more.

As shown in FIG. 9B, each of computing devices 902, 904, 906 and 908 may include one or more processors, memory, data and instructions. Such processors, memories, data and instructions may be configured similarly to the ones described above with regard to FIG. 2.

The various computing devices and vehicles may communication via one or more networks, such as network 916. The network 916, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 902 may include one or more server computing devices having a plurality of computing devices, e.g., a load balanced server farm, that exchange information with different nodes of a network for the purpose of receiving, processing and transmitting the data to and from other computing devices. For instance, computing device 902 may include one or more server computing devices that are capable of communicating with the computing devices of vehicles 912 and/or 914, as well as computing devices 904, 906 and 908 via the network 916. For example, vehicles 912 and/or 914 may be a part of a fleet of vehicles that can be dispatched by a server computing device to various locations. In this regard, the computing device 902 may function as a dispatching server computing system which can be used to dispatch vehicles to different locations in order to pick up and drop off passengers or to pick up and deliver cargo. In addition, server computing device 902 may use network 916 to transmit and present information to a user of one of the other computing devices or a passenger of a vehicle. In this regard, computing devices 904, 906 and 908 may be considered client computing devices.

As shown in FIG. 9A each client computing device 904, 906 and 908 may be a personal computing device intended for use by a respective user 918, and have all of the components normally used in connection with a personal computing device including a one or more processors (e.g., a central processing unit (CPU)), memory (e.g., RAM and internal hard drives) storing data and instructions, a display (e.g., a monitor having a screen, a touch-screen, a projector, a television, or other device such as a smart watch display that is operable to display information), and user input devices (e.g., a mouse, keyboard, touchscreen or microphone). The client computing devices may also include a camera for recording video streams, speakers, a network interface device, and all of the components used for connecting these elements to one another.

Although the client computing devices may each comprise a full-sized personal computing device, they may alternatively comprise mobile computing devices capable of wirelessly exchanging data with a server over a network such as the Internet. By way of example only, client computing devices 906 and 908 may be mobile phones or devices such as a wireless-enabled PDA, a tablet PC, a wearable computing device (e.g., a smartwatch), or a netbook that is capable of obtaining information via the Internet or other networks.

In some examples, client computing device 904 may be a remote assistance workstation used by an administrator or operator to communicate with passengers of dispatched vehicles. Although only a single remote assistance workstation 904 is shown in FIGS. 9A-9B, any number of such workstations may be included in a given system. Moreover, although operations work station is depicted as a desktop-type computer, operations work stations may include various types of personal computing devices such as laptops, netbooks, tablet computers, etc.

Storage system 910 can be of any type of computerized storage capable of storing information accessible by the server computing devices 902, such as a hard-drive, memory card, ROM, RAM, DVD, CD-ROM, flash drive and/or tape drive. In addition, storage system 910 may include a distributed storage system where data is stored on a plurality of different storage devices which may be physically located at the same or different geographic locations. Storage system 910 may be connected to the computing devices via the network 916 as shown in FIGS. 9A-B, and/or may be directly connected to or incorporated into any of the computing devices.

In a situation where there are passengers, the vehicle or remote assistance may communicate directly or indirectly with the passengers' client computing device. Here, for example, information may be provided to the passengers regarding current driving operations, changes to the route in response to the situation, etc.

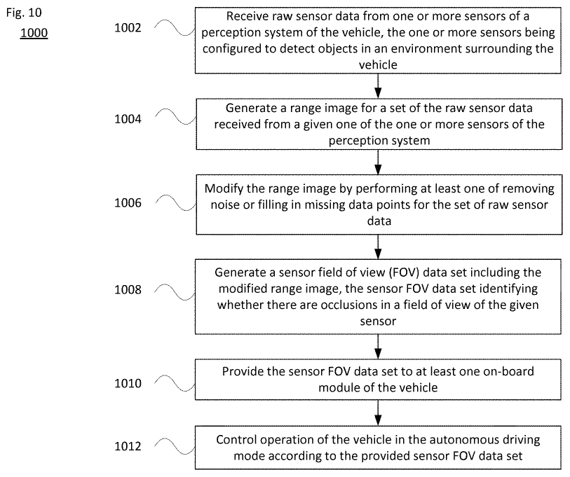

FIG. 10 illustrates an example method of operation 1000 of a vehicle in an autonomous driving mode in accordance with the above discussions. At block 1002, the system receives raw sensor data from one or more sensors of a perception system of the vehicle. The one or more sensors are configured to detect objects in an environment surrounding the vehicle.

At block 1004, a range image is generated for a set of the raw sensor data received from a given one of the one or more sensors of the perception system. At block 1006, the range image is modified by performing at least one of removing noise or filling in missing data points for the set of raw sensor data. At block 1008, a sensor field of view (FOV) data set including the modified range image is generated. The sensor FOV data set identifies whether there are occlusions in a field of view of the given sensor

At block 1010, the sensor FOV data set is provided to at least one on-board module of the vehicle. And at block 1012, the system is configured to control operation of the vehicle in the autonomous driving mode according to the provided sensor FOV data set.

Finally, as noted above, the technology is applicable for various types of wheeled vehicles, including passenger cars, buses, RVs and trucks or other cargo carrying vehicles.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements. The processes or other operations may be performed in a different order or simultaneously, unless expressly indicated otherwise herein.

1. A method of operating a vehicle in an autonomous driving mode, the method comprising:
receiving, by one or more processors, raw sensor data from one or more sensors of a perception system of the vehicle, the one or more sensors being configured to detect objects in an environment surrounding the vehicle;
generating, by the one or more processors, a range image for a set of the raw sensor data received from a given one of the one or more sensors of the perception system;
modifying, by the one or more processors, the range image by performing at least one of removing noise or filling in missing data points for the set of raw sensor data;
generating, by the one or more processors, a sensor field of view (FOV) data set including the modified range image, the sensor FOV data set identifying whether there are occlusions in a field of view of the given sensor;
providing the sensor FOV data set to at least one on-board module of the vehicle; and
controlling operation of the vehicle in the autonomous driving mode according to the provided sensor FOV data set.

2. The method of claim 1, wherein removing the noise includes filtering out noise values from the range image based on a last-returned result received by the given sensor.

3. The method of claim 1, wherein filling in the missing data points includes representing portions of the range image having the missing data points in a same way as one or more adjacent areas of the range image.

4. The method of claim 1, wherein modifying the range image includes applying a heuristic correction approach.

5. The method of claim 4, wherein the heuristic correction approach includes tracking one or more detected objects in the environment surrounding the vehicle over a period of time to determine how to correct perception data associated with the one or more detected objects.

6. The method of claim 5, wherein the perception data associated with the one or more detected objects is corrected by filling in data holes associated with a given detected object.

7. The method of claim 5, wherein the perception data associated with the one or more detected objects is corrected by interpolating missing pixels according to an adjacent boundary for the one or more detected objects.

8. The method of claim 1, wherein generating the sensor FOV data set further includes compressing the modified range image while maintaining a specified amount of sensor resolution.

9. The method of claim 1, wherein generating the sensor FOV data set includes determining whether to compress the modified range image based on an operational characteristic of the given sensor.

10. The method of claim 9, wherein the operational characteristic is selected from the group consisting of a sensor type, a minimum resolution threshold, and a transmission bandwidth.

11. The method of claim 1, wherein:
providing the sensor data set to at least one on-board module includes providing the sensor data set to a planner module; and
controlling operation of the vehicle in the autonomous driving mode includes the planner module controlling at least one of a direction or speed of the vehicle.

12. The method of claim 11, wherein controlling operation of the vehicle includes:
determining whether an occlusion exists along a particular direction in the environment surrounding the vehicle according to the sensor FOV data set; and
upon determining that the occlusion exists, modifying at least one of the direction or speed of the vehicle to account for the occlusion.

13. The method of claim 1, wherein generating the sensor FOV data set comprises evaluating whether a maximum visible range value is closer than a physical distance of a point of interest to determine whether the point of interest is visible or occluded.

14. The method of claim 1, further including providing the sensor FOV data set to at least one off-board module of a remote computing system.

15. A system configured to operate a vehicle in an autonomous driving mode, the system comprising:
memory; and
one or more processors operatively coupled to the memory, the one or more processors being configured to:
receive raw sensor data from one or more sensors of a perception system of the vehicle, the one or more sensors being configured to detect objects in an environment surrounding the vehicle;
generate a range image for a set of the raw sensor data received from a given one of the one or more sensors of the perception system;
modify the range image by performing at least one of removal of noise or filling in missing data points for the set of raw sensor data;
generate a sensor field of view (FOV) data set including the modified range image, the sensor FOV data set identifying whether there are occlusions in a field of view of the given sensor;
store the generated sensor FOV data set in the memory; and
control operation of the vehicle in the autonomous driving mode according to the stored sensor FOV data set.

16. The system of claim 15, wherein removal of the noise includes filtering out noise values from the range image based on a last-returned result received by the given sensor.

17. The system of claim 15, wherein filling in the missing data points includes representing portions of the range image having the missing data points in a same way as one or more adjacent areas of the range image.

18. The system of claim 15, wherein modification of the range image includes application of a heuristic correction approach.

19. The system of claim 15, wherein generation of the sensor FOV data set includes a determination of whether to compress the modified range image based on an operational characteristic of the given sensor.

20. A vehicle configured to operate in an autonomous driving mode, the vehicle comprising:
the system of claim 15; and
the perception system.
